(19) United States
(12) Patent Application Publication
(10) Pub. No.: US 2025/0071842 A1
(43) Pub. Date: Feb. 27, 2025

(54) METHOD AND APPARATUS FOR WIRELESS COMMUNICATION

(71) Applicant: LENOVO (BEIJING) LIMITED, Beijing (CN)

(72) Inventor: Lianhai Wu, Beijing (CN)

(21) Appl. No.: 18/726,545

(22) PCT Filed: Apr. 24, 2022
(86) PCT No.: PCT/CN2022/088790

§ 371 Date: Jul. 3, 2024

(51) Int. Cl. H04W 76/18; H04W 76/19; H04W 88/04

(52) U.S. Cl. CPC H04W 76/18; H04W 76/19; H04W 88/04

(57) ABSTRACT

Embodiments of the present disclosure relate to methods and apparatuses for wireless communications in a communication system. According to some embodiments of the disclosure, a UE may: transmit an RRC setup request message to a BS via a relay node; and start a timer for RRC setup request in response to transmitting the RRC setup request message. According to some embodiments of the disclosure, a UE may: transmit an RRC reestablishment request message to a BS via a relay node; start a timer for RRC reestablishment request in response to transmitting the RRC reestablishment request message; and stop the timer for RRC reestablishment request when a pre-specified condition is met.

### TECHNICAL FIELD

Embodiments of the present disclosure generally relate to communication technology, and more particularly to wireless communications in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication is may support sidelink communications, in which devices (e.g., UEs) that are relatively close to each other may communicate with one another directly via a sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay node (e.g., a relay UE). In the context of the present disclosure, a UE, which functions as a relay between another UE and a BS, may be referred to as a UE-to-network (U2N) relay.

There is a need for efficiently performing communication in a communication system supporting a U2N relay.

### SUMMARY

Some embodiments of the present disclosure provide a user equipment (UE). The UE may include: a transceiver; and a processor coupled to the transceiver. The processor may be configured to: transmit a radio resource control (RRC) setup request message to a base station (BS) via a relay node; and start a timer for RRC setup request in response to transmitting the RRC setup request message.

Some embodiments of the present disclosure provide a user equipment (UE). The UE may include: a transceiver; and a processor coupled to the transceiver. The processor may be configured to: transmit a radio resource control (RRC) reestablishment request message to a base station (BS) via a relay node; start a timer for RRC reestablishment request in response to transmitting the RRC reestablishment request message; and stop the timer for RRC reestablishment request when a pre-specified condition is met.

In some embodiments, the pre-specified condition may include at least one of the following: the relay node becomes no longer suitable; the UE performs a relay reselection or cell reselection; a serving cell of the UE changes; the UE determines to maintain a PC5 link between the UE and the relay node in response to receiving a notification message from the relay node or in response to detecting a radio link failure (RLF) on the PC5 link between the UE and the relay node; or the UE detects an RLF on a PC5 link between the UE and the relay node.

In some embodiments, the processor may be configured to perform the relay reselection or cell reselection in response to detecting an RLF on the PC5 link between the UE and the relay node or receiving the notification message from the relay node.

Some embodiments of the present disclosure provide a method performed by a user equipment (UE). The method may include: transmitting a radio resource control (RRC) setup request message to a base station (BS) via a relay node; and starting a timer for RRC setup request in response to transmitting the RRC setup request message.

Some embodiments of the present disclosure provide a method performed by a user equipment (UE). The method may include: transmitting a radio resource control (RRC) reestablishment request message to a base station (BS) via a relay node; starting a timer for RRC reestablishment request in response to transmitting the RRC reestablishment request message; and stopping the timer for RRC reestablishment request when a pre-specified condition is met.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a relay based wireless communication system in accordance with some embodiments of the present disclosure;

FIG. 3 illustrates a flow chart of an exemplary procedure for establishing a connection in accordance with some embodiments of the present disclosure;

FIG. 4 illustrates a flow chart of an exemplary procedure for reestablishing a connection in accordance with some embodiments of the present disclosure;

FIGS. 5-7 illustrate a flow chart of an exemplary procedure of wireless communications in accordance with some embodiments of the present disclosure;

FIGS. 8 and 9 illustrate is a flow chart of an exemplary communication method in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

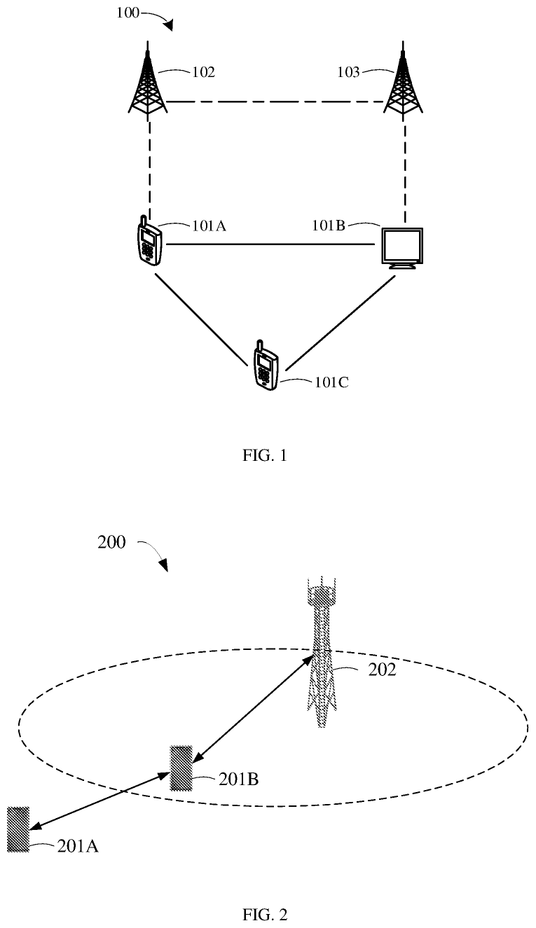

FIG. 1 illustrates a schematic diagram of wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G. long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BS, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be referred to as the serving BS or serving cell of the remote UE.

FIG. 2 illustrates a schematic diagram of a relay based wireless communication system 200 in accordance with some embodiments of the present disclosure. Details described in all of the foregoing embodiments of the present disclosure are applicable for the embodiments shown in FIG. 2.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

A UE (e.g., UE 201A or UE 201B in FIG. 1) may be in one of the following states: RRC_IDLE state, RRC_CONNECTED state, and RRC_INACTIVE state, at a given time. In an RRC_INACTIVE state (hereinafter, “an inactive state”), a UE does not have an RRC connection with the radio access network (RAN), for example, BS 202. However, the RAN keeps a connection with the core network for the UE. Therefore, an RRC_INACTIVE state may achieve power saving with acceptable access latency. The specific characteristics of an RRC_IDLE state, RRC_CONNECTED state, and RRC_INACTIVE state are defined in 3GPP specifications.

Reachability management is responsible for detecting whether a UE is reachable and providing a UE location (e.g., access node) for the network to reach the UE. This is done by, for example, UE paging and UE location tracking. The UE location tracking may include UE registration area tracking (i.e., UE registration area update) and UE reachability tracking (i.e., UE periodic registration area update). In view of the above, there may be two trigger conditions for triggering a UE to perform a core network (CN) registration. The two trigger conditions are registration area change and registration timer (e.g., a periodic registration update timer or a periodic registration timer) expiry.

On one hand, a CN registration area (e.g., TrackingAreaCode information element (IE)) may be broadcast by a system information block (SIB) (e.g., SIB1). When an idle UE leaves a registration area, the idle UE may need to perform a CN registration by establishing a connection with the network.

On the other hand, a periodic registration timer value may be allocated by, for example, an access and mobility management function (AMF), to a UE based on, for example, local policies, subscription information and information provided by the UE. Whenever a UE in an RM-REGISTERED state enters a CM-IDLE state, the UE may start a periodic registration timer according to the periodic registration timer value from the AMF during a registration procedure. In response to the expiry of the periodic registration timer, the UE may perform a periodic CN registration. The idle UE may perform a CN registration by establishing a connection with the network. The specific characteristics of an RM-REGISTERED state and CM-IDLE state are defined in 3GPP specifications.

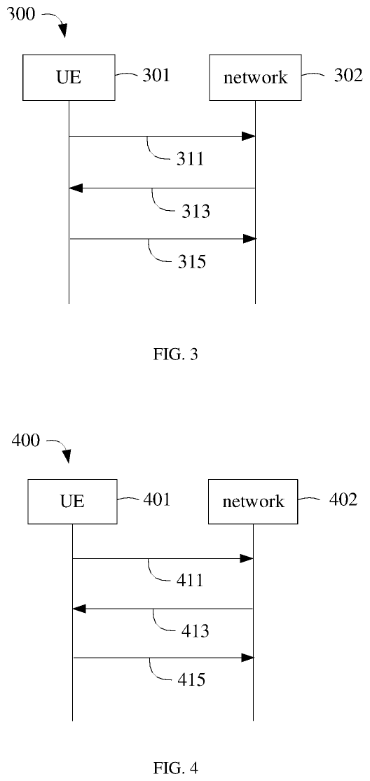

FIG. 3 illustrates a flow chart of exemplary procedure 300 for establishing an RRC connection in accordance with some embodiments of the present disclosure. Details described in all of the foregoing embodiments of the present disclosure are applicable for the embodiments shown in FIG. 3.

Referring to FIG. 3, in operation 311, UE 301 may transmit an RRC setup request message to network 302 (e.g., a BS or a cell). In response to transmitting the RRC setup request message, UE 301 may start a timer for RRC setup request (e.g., T300 as specified in 3GPP specifications). In response to the RRC setup request, network 302 may transmit an RRC setup message to UE 301 in operation 313. In response to receiving the RRC setup message, UE 301 may stop the timer for RRC setup request. UE 301 may apply configurations according to the RRC setup message and may transmit an RRC setup complete message to network 302 in operation 315.

The purpose of exemplary procedure 300 is to establish an RRC connection, which may involve signaling radio bearer 1 (SRB1) establishment. Exemplary procedure 300 may also be used to transfer the initial non-access stratum (NAS) dedicated information or message from a UE to a network.

A UE may initiate exemplary procedure 300 when, for example, the upper layer(s) of the UE requests an establishment of an RRC connection while the UE is in an RRC_IDLE state and the UE has acquired essential system information, or for a sidelink communication.

A network may apply exemplary procedure 300 when, for example, establishing an RRC connection (e.g., with a UE). In some examples, the network may apply the procedure when a UE is resuming or reestablishing an RRC connection, and the network is not able to retrieve or verify the UE context. In this case, the UE may receive an RRC setup message and respond with an RRC setup complete message.

It should be appreciated by persons skilled in the art that the sequence of the operations in exemplary procedure 300 may be changed and that some of the operations in exemplary procedure 300 may be eliminated or modified, without departing from the spirit and scope of the disclosure.

FIG. 4 illustrates a flow chart of exemplary procedure 400 for reestablishing an RRC connection in accordance with some embodiments of the present disclosure. Details described in all of the foregoing embodiments of the present disclosure are applicable for the embodiments shown in FIG. 4.

The purpose of exemplary procedure 400 is to reestablish an RRC connection. In response to the initiation of the procedure, UE 401 may start a timer for initiating RRC reestablishment (e.g., T311 as specified in 3GPP specifications) and perform cell or relay selection. In response to selecting a suitable relay node (e.g., an L2 U2N relay UE), UE 401 (e.g., remote UE) may stop the timer for initiating RRC reestablishment. UE 401 may transmit an RRC reestablishment request message to network 402 (e.g., a BS or a cell) in operation 411. UE 401 may start a timer for RRC reestablishment request (e.g., T301 as specified in 3GPP specifications) in response to transmitting the RRC reestablishment request message.

In response to the RRC reestablishment request, network 402 may transmit an RRC reestablishment message to UE 401 in operation 413. In response to receiving the RRC reestablishment message, UE 401 may stop the timer for RRC reestablishment request. UE 401 may apply configurations according to the RRC reestablishment message and may transmit an RRC reestablishment complete message to network 402 in operation 415.

It should be appreciated by persons skilled in the art that the sequence of the operations in exemplary procedure 400 may be changed and that some of the operations in exemplary procedure 400 may be eliminated or modified, without departing from the spirit and scope of the disclosure.

Various issues need to be solved during a connection setup procedure, the CN registration procedure and a reestablishment procedure in a network supporting a U2N relay. More details on the embodiments of the present disclosure will be illustrated in the following text in combination with the appended drawings.

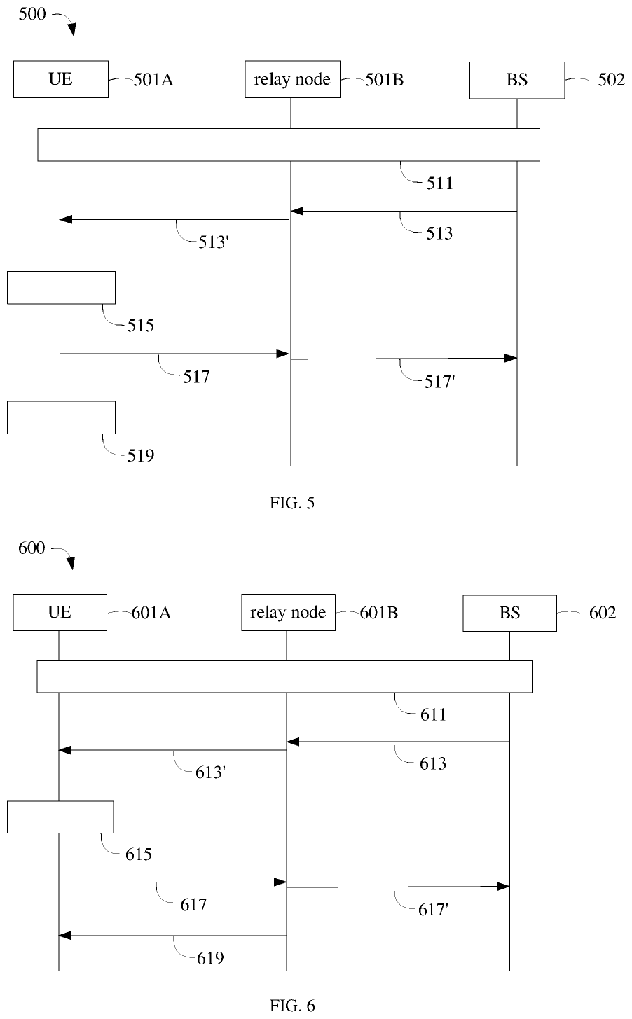

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, in operation 511, UE 501A may access BS 502 via relay node 501B. In some embodiments, relay node 501B may be a UE (e.g., an L2 U2N relay UE). In some embodiments, BS 502 may transmit an indication of whether a relay node (e.g., a relay UE or an L2 U2N relay UE) is supported or not.

In operations 513 and 513′, BS 502 may transmit an RRC release message to UE 501A via relay node 501B. In operation 515, in response to receiving the RRC release message, UE 501A may enter an idle state (e.g., RRC_IDLE state).

In some cases, UE 501A may initiate a procedure for connection setup when, for example, an upper layer(s) of UE 501A requests an establishment of an RRC connection while UE 501A is in an idle state. In some embodiments, UE 501A may transmit an RRC setup request message to the network. For example, UE 501A may transmit an RRC setup request message to BS 502 via relay node 501B in operations 517 and 517′. In response to transmitting the RRC setup request message, UE 501 may start a timer for RRC setup request (e.g., T300 as specified in 3GPP specifications).

In some embodiments of the present disclosure, after initiating the RRC setup procedure (e.g., after the transmission of the RRC setup request message), UE 501A may detect an RLF on the PC5 link between UE 501A and relay node 501B.

In some embodiments of the present disclosure, after initiating the RRC setup procedure (e.g., after the transmission of the RRC setup request message), UE 501A may receive a notification message from relay node 501B. The notification message may indicate at least one of the following: a handover of relay node 501B, an RLF between relay node 501B and BS 502, a cell reselection of relay node 501B, or an RRC connection failure of relay node 501B. For example, relay node 501B may transmit the notification message in response to at least one of the following conditions: a Uu RLF at relay node 501B; receiving an RRC reconfiguration message including the reconfiguration WithSync IE; cell reselection of relay node 501B; or an RRC connection failure. The RRC connection failure of relay node 501B may include an RRC connection rejection at relay node 501B, an expiry of a timer for RRC setup request (e.g., T300 as specified in 3GPP specifications) at relay node 501B, and an RRC resume failure at relay node 501B.

In operation 519, UE 501A may stop the timer for RRC setup request, which is started in response to transmitting the RRC setup request message in operation 517, under certain conditions.

For example, UE 501A may determine to keep the PC5 link between UE 501A and relay node 501B in response to detecting the RLF on the PC5 link between UE 501A and relay node 501B or in response to receiving the notification message. Then, UE 501A may stop the timer for RRC setup request.

For example, UE 501A may stop the timer for RRC setup request when at least one of the following conditions is met:
UE 501A determines to keep the PC5 link between UE 501A and relay node 501B after UE 501A receives the notification message from relay node 501B;
UE 501A determines to keep the PC5 link between UE 501A and relay node 501B after UE 501A receives the notification message from relay node 501B and a serving cell of UE 501A changes;
a serving cell of UE 501A changes;
UE 501A receives the notification message from relay node 501B; or
UE 501A detects an RLF on the PC5 link between UE 501A and relay node 501B.

In some embodiments, the serving cell of UE 501A changes due to: a handover of relay node 501B, an RLF between relay node 501B and BS 502, a cell reselection of relay node 501B, or an RRC connection failure of relay node 501B. The RRC connection failure of relay node 501B may include an RRC connection rejection at relay node 501B, an expiry of a timer for RRC setup request (e.g., T300 as specified in 3GPP specifications) at relay node 501B, and an RRC resume failure at relay node 501B.

It should be noted that the RRC setup request message is not necessarily transmitted to the original BS (e.g., BS 502, which sent UE 501A to the idle state) and not necessarily transmitted via the original relay node (e.g., relay node 501B, which forwarded the RRC release message to UE 501A). In this sense, operations 517 and 517′ are only for an illustrative purpose. In some examples, UE 501A may transmit the RRC setup request message to a different BS via a different relay node, to the original BS via a different relay node, or to a different BS via the original relay node. In these examples, the descriptions with respect to operations 517-519 in the above text may be accordingly modified. For example, UE 501A may transmit the RRC setup request message via a different relay node (denoted as relay #1). UE 501A may detect an RLF on the PC5 link between UE 501A and relay #1. UE 501A may receive a notification message from relay #1.

It should be appreciated by persons skilled in the art that the sequence of the operations in exemplary procedure 500 may be changed and that some of the operations in exemplary procedure 500 may be eliminated or modified, without departing from the spirit and scope of the disclosure.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, UE 601A may access BS 602 via relay node 601B. In some embodiments, relay node 601B may be a UE (e.g., an L2 U2N relay UE). In some embodiments, BS 602 may transmit an indication of whether a relay node (e.g., a relay UE or an L2 U2N relay UE) is supported or not.

In operations 613 and 613′, BS 602 may transmit an RRC release message to UE 601A via relay node 601B. In operation 615, in response to receiving the RRC release message, UE 601A may enter an idle state (e.g., RRC_IDLE state).

In some cases, UE 601A may initiate a procedure for connection setup when, for example, a mobility registration update is triggered or an upper layer(s) of UE 601A requests. The mobility registration update may be triggered in response to a tracking area change or an expiry of a periodic registration timer. For example, in some embodiments, UE 601A may transmit an RRC setup request message to the network. For example, UE 601A may transmit an RRC setup request message to BS 602 via relay node 601B in operations 617 and 617′. In response to transmitting the RRC setup request message, UE 601 may start a timer for RRC setup request (e.g., T300 as specified in 3GPP specifications).

In some embodiments of the present disclosure, after initiating the RRC setup procedure (e.g., after the transmission of the RRC setup request message), UE 601A may receive a notification message from relay node 601B in operation 619. The notification message may indicate at least one of the following: a handover of relay node 601B, an RLF between relay node 601B and BS 602, a cell reselection of relay node 601B, or an RRC connection failure of relay node 601B. For example, relay node 601B may transmit the notification message in response to at least one of the following conditions: a Uu RLF at relay node 601B; receiving an RRC reconfiguration message including the reconfiguration WithSync IE; cell reselection of relay node 601B; or an RRC connection failure. The RRC connection failure of relay node 601B may include an RRC connection rejection at relay node 601B, an expiry of a timer for RRC setup request (e.g., T300 as specified in 3GPP specifications) at relay node 601B, and an RRC resume failure at relay node 601B.

In some embodiments, UE 601A may determine a serving cell change of UE 601A, which may occur due to the serving cell change of relay node 601B. For example, the serving cell change of UE 601A may occur due to: a handover of relay node 601B, an RLF between relay node 601B and BS 602, a cell reselection of relay node 601B, or an RRC connection failure of relay node 601B. In some embodiments, the new serving cell of UE 601A (e.g., the new serving cell of relay node 601B) may be outside of a tracking area configured for UE 601A. In response to such serving cell change of UE 601A. UE 601A may prohibit triggering a mobility registration update procedure since there is an ongoing connection setup procedure or there is an ongoing mobility registration update as described above with respect to operations 617 and 617′.

To put it another way, UE 601A may initiate a mobility registration update, for example, transmitting an RRC setup request to the network, in response to its serving cell changes (e.g., due to the cell change of relay node 601B) to a cell outside of the tracking area configured for UE 601A when at least one of the following conditions is met:
a timer for RRC setup request (e.g., T300 as specified in 3GPP specifications) is not running at UE 601A;
UE 601A does not perform (or is performing) a connection setup procedure; or
UE 601A determines to maintain the PC5 link (e.g., the current PC5 RRC connection) between UE 601A and relay node 601B.

It should be noted that the RRC setup request message is not necessarily transmitted to the original BS (e.g., BS 602, which sent UE 601A to the idle state) and not necessarily transmitted via the original relay node (e.g., relay node 601B, which forwarded the RRC release message to UE 601A). In this sense, operations 617 and 617′ are only for an illustrative purpose. In some examples, UE 601A may transmit the RRC setup request message to a different BS via a different relay node, to the original BS via a different relay node, or to a different BS via the original relay node. In these examples, the descriptions with respect to operations 617-619 in the above text may be accordingly modified. For example, UE 601A may transmit the RRC setup request message via a different relay node (denoted as relay #2). UE 601A may receive a notification message from relay #2.

It should be appreciated by persons skilled in the art that the sequence of the operations in exemplary procedure 600 may be changed and that some of the operations in exemplary procedure 600 may be eliminated or modified, without departing from the spirit and scope of the disclosure.

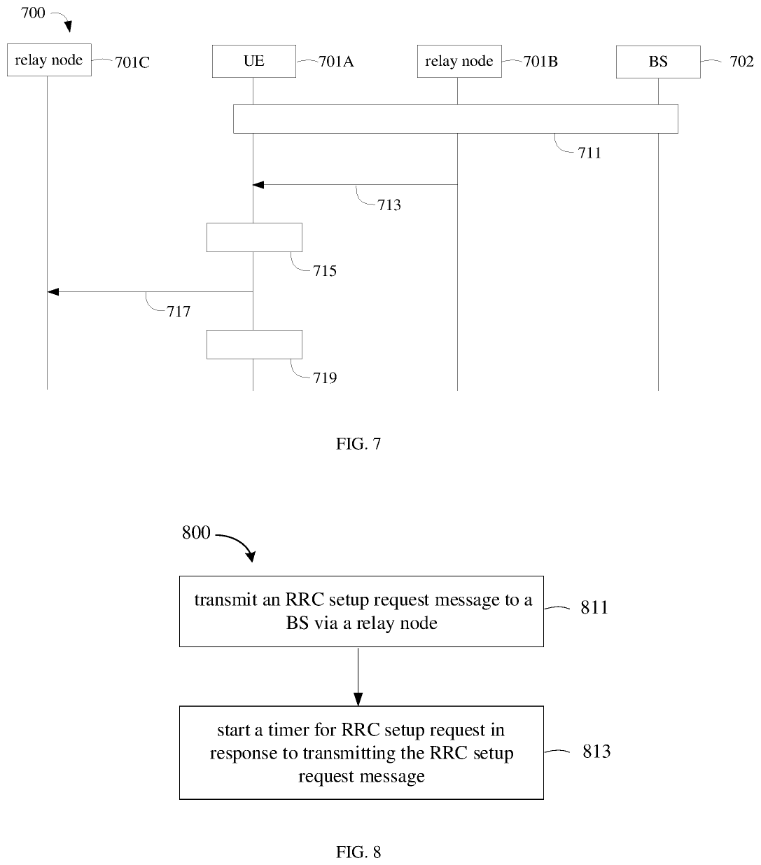

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7.

Referring to FIG. 7, in operation 711, UE 701A may access BS 702 via relay node 701B. In some embodiments, relay node 701B may be a UE (e.g., an L2 U2N relay UE). In some embodiments, BS 702 may transmit an indication of whether a relay node (e.g., a relay UE or an L2 U2N relay UE) is supported or not.

In operations 713, UE 701A may receive a notification message from relay node 701B. The descriptions regarding the notification message as mentioned in the foregoing embodiments may apply here.

In operation 715, in response to receiving the notification message, UE 701A may initiate a reestablishment procedure. For example, UE 701A may reselect a relay node (e.g., relay node 701C). UE 701A may transmit an RRC reestablishment request message to relay node 701C in operation 717, and start a timer for RRC reestablishment request (e.g., T301 as specified in 3GPP specifications) in response to transmitting the RRC reestablishment request message. Relay node 701C may transmit the received RRC reestablishment request message to the network (e.g., a BS not shown in FIG. 7).

It should be noted that UE 701A may initiate a reestablishment procedure for various reasons, including but not limited to the reception of the notification message as shown for illustrative purpose in FIG. 7.

In some embodiments of the present disclosure, after initiating the reestablishment procedure (e.g., after the transmission of the RRC reestablishment request message), UE 701A may detect an RLF on the PC5 link between UE 701A and relay node 701C.

In some embodiments of the present disclosure, after initiating the reestablishment procedure (e.g., after the transmission of the RRC reestablishment request message), UE 701A may receive a notification message from relay node 701C. The descriptions regarding the notification message as mentioned in the foregoing embodiments may apply here. For example, the notification message may indicate at least one of the following: a handover of relay node 701C, an RLF between relay node 701C and the serving BS of relay node 701C, a cell reselection of relay node 701C, or an RRC connection failure of relay node 701C. For example, relay node 701C may transmit the notification message in response to at least one of the following conditions: a Uu RLF at relay node 701C; receiving an RRC reconfiguration message including the reconfiguration WithSync IE; cell reselection of relay node 701C; or an RRC connection failure. The RRC connection failure of relay node 701C may include an RRC connection rejection at relay node 701C, an expiry of a timer for RRC setup request (e.g., T300 as specified in 3GPP specifications) at relay node 701C, and an RRC resume failure at relay node 701C.

In operation 719, UE 701A may stop the timer for RRC reestablishment request (e.g., T301 as specified in 3GPP specifications), which is started in response to transmitting the RRC reestablishment request message in operation 717, under certain conditions. In some embodiments, UE 701A may enter an idle state under the certain conditions.

In some embodiments, UE 701A may stop the timer for RRC reestablishment request when relay node 701C becomes no longer suitable. Relay node 701C may be considered suitable by UE 701A (e.g., in terms of radio criteria) when the PC5 link quality measured by UE 701A towards relay node 701C exceeds a threshold. The threshold may be configured or pre-configured by the network (e.g., a BS) or predefined (e.g., in a standard). For example, UE 701A may consider that relay node 701C is no longer suitable when the PC5 link between UE 701A and relay node 701C is less than or equal to the threshold.

In some embodiments, UE 701A may perform a relay reselection or cell reselection in response to detecting the RLF on the PC5 link between UE 701A and relay node 701C or in response to receiving the notification message from relay node 701C. Then, UE 701A may stop the timer for RRC reestablishment request.

In some embodiments, UE 701A may determine to keep the PC5 link between UE 701A and relay node 701C in response to detecting the RLF on the PC5 link between UE 701A and relay node 701C or in response to receiving the notification message from relay node 701C. In some examples, UE 701A may stop the timer for RRC reestablishment request in response to the determination of keeping the PC5 link. In some examples, UE 701A may not stop the timer for RRC reestablishment request in response to the determination of keeping the PC5 link.

In some embodiments, UE 701A may stop the timer for RRC reestablishment request when at least one of the following conditions is met:
relay node 701C becomes no longer suitable;
UE 701A performs a relay reselection or cell reselection;
a serving cell of UE 701A changes;
UE 701A determines to maintain the PC5 link (e.g., current PC5 RRC connection) between UE 701A and relay node 701C in response to detecting the RLF on the PC5 link between UE 701A and relay node 701C or in response to receiving the notification message from relay node 701C; or
UE 701A detects the RLF on the PC5 link between UE 701A and relay node 701C.

In some embodiments, UE 701A may perform the relay reselection or cell reselection in response to detecting the RLF on the PC5 link between UE 701A and relay node 701C or in response to receiving the notification message from relay node 701C.

In some embodiments, the serving cell of UE 701A changes due to: a handover of relay node 701C, an RLF between relay node 701C and BS 702, a cell reselection of relay node 701C, or an RRC connection failure of relay node 701C. The RRC connection failure of relay node 701C may include an RRC connection rejection at relay node 701C, an expiry of a timer for RRC setup request (e.g., T300 as specified in 3GPP specifications) at relay node 701C, and an RRC resume failure at relay node 701C.

As stated above, in some embodiments, UE 701A may enter the idle state when at least one of the above described conditions is met. In some embodiments, UE 701A may perform at least one of the following actions in response to entering the idle state:
reset media access control (MAC);
set the variable pending RAN-based notification area (RNA) update indicator (e.g., pendingRNA-Update) to “false”, if it is set to “true”;
discard the UE inactive AS context, if any;
release the suspend configuration (e.g., suspendConfig), if configured;
remove all the entries within the variable conditional reconfiguration (e.g., VarConditionalReconfig), if any; or
indicate the release of the RRC connection to an upper layer(s).

It should be appreciated by persons skilled in the art that the sequence of the operations in exemplary procedure 700 may be changed and that some of the operations in exemplary procedure 700 may be eliminated or modified, without departing from the spirit and scope of the disclosure.

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. In some examples, the procedure may be performed by a UE (e.g., a remote UE).

Referring to FIG. 8, in operation 811, a UE may transmit an RRC setup request message to a BS via a relay node. In operation 813, the UE may start a timer for RRC setup request (e.g., T300 as specified in 3GPP specifications) in response to transmitting the RRC setup request message.

In some embodiments, the UE may stop the timer for RRC setup request when at least one of the following conditions is met: the UE determines to keep a PC5link between the UE and the relay node after the UE receives a notification message from the relay node; the UE determines to keep a PC5 link between the UE and the relay node after the UE receives a notification message from the relay node and a serving cell of the UE changes; a serving cell of the UE changes; the UE receives a notification message from the relay node; or the UE detects a radio link failure (RLF) on a PC5 link between the UE and the relay node.

In some embodiments, the serving cell of the UE changes due to a handover of the relay node, an RLF between the relay node and the BS, a cell reselection of the relay node, or an RRC connection failure of the relay node.

In some embodiments, the notification message may indicate at least one of: a handover of the relay node, an RLF between the relay node and the BS, a cell reselection of the relay node, or an RRC connection failure of the relay node.

In some embodiments, the RRC connection failure of the relay node may include an RRC connection rejection at the relay node, an expiry of a timer for RRC setup request at the relay node, and an RRC resume failure at the relay node.

In some embodiments, the UE may transmit the RRC setup request in response to a first mobility registration update procedure being triggered.

In some embodiments, the UE may prohibit triggering a second mobility registration update procedure during the RRC setup in response to a serving cell change of the UE.

In some embodiments, the first mobility registration update may be triggered in response to a tracking area change or an expiry of a periodic registration timer.

In some embodiments, the UE may transmit the RRC setup request in response to that a serving cell of the UE changes to a cell outside of a tracking area configured for the UE when at least one of the following conditions is met: a timer for RRC setup request is not running; the UE does not perform a connection setup procedure; or the UE determines to maintain a PC5 link between the UE and the relay node.

It should be appreciated by persons skilled in the art that the sequence of the operations in exemplary procedure 800 may be changed and some of the operations in exemplary procedure 800 may be eliminated or modified, without departing from the spirit and scope of the disclosure.

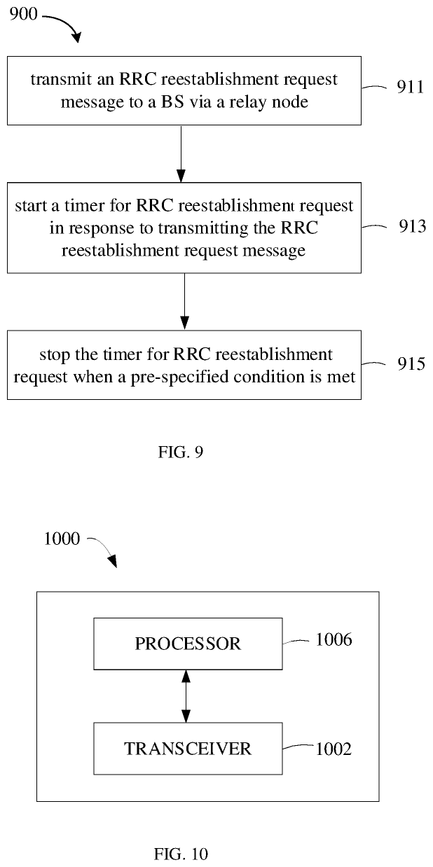

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a UE (e.g., a remote UE).

Referring to FIG. 9, in operation 911, a UE may transmit an RRC reestablishment request message to a BS via a relay node. In operation 913, the UE may start a timer for RRC reestablishment request (e.g., T301 as specified in 3GPP specifications) in response to transmitting the RRC reestablishment request message. In operation 915, the UE may stop the timer for RRC reestablishment request when a pre-specified condition is met.

In some embodiments, the pre-specified condition may include at least one of the following: the relay node becomes no longer suitable; the UE performs a relay reselection or cell reselection; a serving cell of the UE changes; the UE determines to maintain a PC5 link between the UE and the relay node in response to receiving a notification message from the relay node or in response to detecting an RLF on the PC5 link between the UE and the relay node; or the UE detects an RLF on a PC5 link between the UE and the relay node.

In some embodiments, the UE may perform at least one of the following: entering an idle state when the pre-specified condition is met; or performing actions associated with an idle state in response to entering the idle state when the pre-specified condition is met.

In some embodiments, the serving cell of the UE may change due to a handover of the relay node, an RLF between the relay node and the BS, a cell reselection of the relay node, or an RRC connection failure of the relay node.

In some embodiments, the notification message may indicate at least one of: a handover of the relay node, an RLF between the relay node and the BS, a cell reselection of the relay node, or an RRC connection failure of the relay node.

In some embodiments, the RRC connection failure of the relay node may include an RRC connection rejection at the relay node, an expiry of a timer for RRC setup request at the relay node, and an RRC resume failure at the relay node.

In some embodiments, the UE may perform the relay reselection or cell reselection in response to detecting an RLF on the PC5 link between the UE and the relay node or receiving the notification message from the relay node.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a block diagram of exemplary apparatus 1000 according to some embodiments of the present disclosure.

As shown in FIG. 10, the apparatus 1000 may include at least one processor 1006 and at least one transceiver 1002 coupled to the processor 1006. The apparatus 1000 may be a BS, a relay node, or a UE.

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be a UE. The transceiver 1002 and the processor 1006 may interact with each other so as to perform the operations with respect to the UEs described in FIGS. 1-9. In some embodiments of the present application, the apparatus 1000 may be a relay node. The transceiver 1002 and the processor 1006 may interact with each other so as to perform the operations with respect to the relay nodes described in FIGS. 1-9. In some embodiments of the present application, the apparatus 1000 may be a BS. The transceiver 1002 and the processor 1006 may interact with each other so as to perform the operations with respect to the BSs described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UEs as described above. For example, the computer-executable instructions, when executed, cause the processor 1006 interacting with transceiver 1002 to perform the operations with respect to the UEs described in FIGS. 1-9.

In some embodiments of the present disclosure, the non-transitory computer-readable medium may have stored thereon computer-executable instructions to cause the processor 1006 to implement the method with respect to the relay nodes as described above. For example, the computer-executable instructions, when executed, cause the processor 1006 interacting with transceiver 1002 to perform the operations with respect to the relay nodes described in FIGS. 1-9.

In some embodiments of the present disclosure, the non-transitory computer-readable medium may have stored thereon computer-executable instructions to cause the processor 1006 to implement the method with respect to the BSs as described above. For example, the computer-executable instructions, when executed, cause the processor 1006 interacting with transceiver 1002 to perform the operations with respect to the BSs described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
transmit a radio resource control (RRC) setup request message to a base station via a relay node; and
start a timer for RRC setup request in response to transmitting the RRC setup request message.

2. The UE of claim 1, wherein the at least one processor is configured to cause the UE to stop the timer for RRC setup request when at least one of the following conditions is met:
the UE determines to keep a PC5 link between the UE and the relay node after the UE receives a notification message from the relay node;
the UE determines to keep a PC5 link between the UE and the relay node after the UE receives a notification message from the relay node and a serving cell of the UE changes;
a serving cell of the UE changes;
the UE receives a notification message from the relay node; or
the UE detects a radio link failure (RLF) on a PC5 link between the UE and the relay node.

3. The UE of claim 2, wherein the serving cell of the UE changes due to a handover of the relay node, an RLF between the relay node and the base station, a cell reselection of the relay node, or an RRC connection failure of the relay node.

4. The UE of claim 2, wherein the notification message indicates at least one of: a handover of the relay node, an RLF between the relay node and the base station, a cell reselection of the relay node, or an RRC connection failure of the relay node.

5. The UE of claim 3, wherein the RRC connection failure of the relay node comprises an RRC connection rejection at the relay node, an expiry of a timer for RRC setup request at the relay node, and an RRC resume failure at the relay node.

6. The UE of claim 1, wherein the at least one processor is configured to cause the UE to transmit the RRC setup request in response to a first mobility registration update procedure being triggered.

7. The UE of claim 1, wherein the at least one processor is configured to cause the UE to prohibit triggering a second mobility registration update procedure during the RRC setup in response to a serving cell change of the UE.

8. The UE of claim 6, wherein the first mobility registration update is triggered in response to a tracking area change or an expiry of a periodic registration timer.

9. The UE of claim 1, wherein the at least one processor is configured to cause the UE to transmit the RRC setup request in response to that a serving cell of the UE changes to a cell outside of a tracking area configured for the UE when at least one of the following conditions is met:
a timer for RRC setup request is not running;
the UE does not perform a connection setup procedure; or
the UE determines to maintain a PC5 link between the UE and the relay node.

10. A user equipment (UE), comprising:
at least one memory; and
at least one processor coupled with the at least one memory and configured to cause the UE to:
transmit a radio resource control (RRC) reestablishment request message to a base station via a relay node;
start a timer for RRC reestablishment request in response to transmitting the RRC reestablishment request message; and
stop the timer for RRC reestablishment request when a pre-specified condition is met.

11. The UE of claim 10, wherein the pre-specified condition comprises at least one of the following:
the relay node becomes no longer suitable;
the UE performs a relay reselection or cell reselection;
a serving cell of the UE changes;
the UE determines to maintain a PC5 link between the UE and the relay node in response to receiving a notification message from the relay node or in response to detecting a radio link failure (RLF) on the PC5 link between the UE and the relay node; or
the UE detects an RLF on a PC5 link between the UE and the relay node.

12. The UE of claim 10, wherein the at least one processor is configured to cause the UE to perform at least one of the following:
entering an idle state when the pre-specified condition is met; or performing actions associated with an idle state in response to entering the idle state when the pre-specified condition is met.

13. The UE of claim 11, wherein the serving cell of the UE changes due to a handover of the relay node, an RLF between the relay node and the base station, a cell reselection of the relay node, or an RRC connection failure of the relay node.

14. The UE of claim 11, wherein the notification message indicates at least one of: a handover of the relay node, an RLF between the relay node and the base station, a cell reselection of the relay node, or an RRC connection failure of the relay node.

15. The UE of claim 13, wherein the RRC connection failure of the relay node comprises an RRC connection rejection at the relay node, an expiry of a timer for RRC setup request at the relay node, and an RRC resume failure at the relay node.

16. The UE of claim 11, wherein the at least one processor is configured to cause the UE to perform the relay reselection or cell reselection in response to detecting an RLF on the PC5 link between the UE and the relay node or receiving the notification message from the relay node.

17. A method performed by a user equipment (UE), the method comprising:
transmitting a radio resource control (RRC) setup request message to a base station via a relay node; and
starting a timer for RRC setup request in response to transmitting the RRC setup request message.

18. A method performed by a user equipment (UE), the method comprising:
transmitting a radio resource control (RRC) reestablishment request message to a base station via a relay node;
starting a timer for RRC reestablishment request in response to transmitting the RRC reestablishment request message; and
stopping the timer for RRC reestablishment request when a pre-specified condition is met.

19. The method of claim 18, wherein a serving cell of the UE changes due to a handover of the relay node, an RLF between the relay node and the base station, a cell reselection of the relay node, or an RRC connection failure of the relay node.

20. The method of claim 18, wherein a notification message indicates at least one of: a handover of the relay node, an RLF between the relay node and the base station, a cell reselection of the relay node, or an RRC connection failure of the relay node.
